(19) United States
(12) Patent Application Publication
(10) Pub. No.: US 2014/0245214 A1
(43) Pub. Date: Aug. 28, 2014

(54) Enabling search in a touchscreen device

(71) Applicant: HCL Technologies Limited, Chennai (IN)

(72) Inventors: Akhilesh Chandra Singh, Noida (IN); Arindam Dutta, Noida (IN)

(73) Assignee: HCL Technologies Limited, Chennai (IN)

(21) Appl. No.: 13/902,642

(22) Filed: May 24, 2013

(30) Foreign Application Priority Data
Feb. 28, 2013 (IN) 891/CHE/2013

(51) Int. Cl. G06F 3/0484

(52) U.S. Cl. CPC G06F 3/0484
USPC 715/780

(57) ABSTRACT

Enabling search in a touchscreen device. This embodiment relates to electronic devices, and more particularly to electronic devices with a touchscreen. The principal object of this embodiment is to enable a user to perform a search in a text based data in a single step on a touch screen based device.

### PRIORITY DETAILS

The present application claims priority from Indian Application Number 891/CHE/2013, filed on 28 Feb. 2013, the disclosure of which is hereby incorporated by reference herein.

### TECHNICAL FIELD

This embodiment relates to electronic devices, and more particularly to electronic devices with a touchscreen.

### BACKGROUND OF EMBODIMENT

Currently, users are accessing large amounts of data on electronic devices. The data may comprise of text based data. The user may desire to search the text for a specific word or a phrase.

In a conventional non-touch based device, the user may search by first clicking on a ‘search’ button present within the user interface. Clicking on the ‘search’ button will bring a ‘search’ window, where the user may enter the text to be entered. The ‘search’ button may be present in a menu option present within the menu, wherein the user is required to navigate the menu to access the ‘search’ button. The user may also use a keyboard based shortcut to bring up the ‘search’ window. The above process may be implemented in a touch screen based device.

The above process is quite cumbersome for a user using a touch screen device, as the user has to press multiple buttons and/or keys to bring up the ‘search’ window. This leads to a deterioration in the user experience.

### OBJECT OF EMBODIMENT

The principal object of this embodiment is to enable a user to perform a search in a text based data in a single step on a touch screen based device.

### SUMMARY

Embodiments herein disclose a method for enabling a user to perform a search on a touchscreen device, the method comprising of triggering an invisible search bar by the device, on the device detecting that the user viewing text on the device; making the search bar visible to the user by the device, on the device detecting that the user has made a pre-determined gesture; and performing a search by the device based on the text entered by the user in the search bar.

Embodiments herein discloses a touchscreen device configured for enabling a user to perform a search on the device, the device configured for triggering an invisible search bar, on the device detecting that the user viewing text on the device; making the search bar visible to the user, on the device detecting that the user has made a pre-determined gesture; and performing a search based on the text entered by the user in the search bar.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF FIGURES

This embodiment is illustrated in the accompanying drawings, through out which like reference letters indicate corresponding parts in the various figures. The embodiments herein will be better understood from the following description with reference to the drawings, in which:

FIG. 1 depicts a touch screen based electronic device, according to embodiments as disclosed herein;

FIG. 2 depicts the internal modules present within the touch based electronic device, according to embodiments as disclosed herein;

FIGS. 3a and 3b are flowcharts illustrating the process of enabling a user to perform a search in text based data on a touch screen electronic device, according to embodiments as disclosed herein; and

FIGS. 4a, 4b, 4c and 4d depict the user performing a search in text based data on a touch screen electronic device, according to embodiments as disclosed herein.

### DETAILED DESCRIPTION OF EMBODIMENT

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

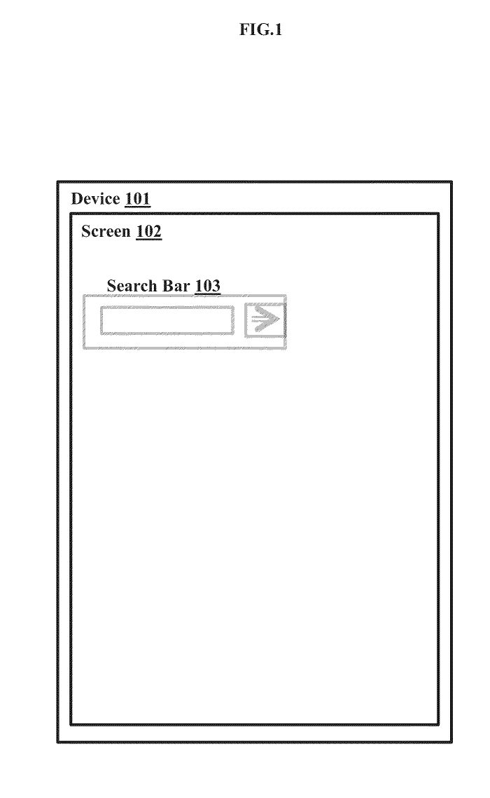

The embodiments herein enable a user to perform a search in a text based data in a single step on a touch screen based device. Referring now to the drawings, and more particularly to FIGS. 1 through 4, where similar reference characters denote corresponding features consistently throughout the figures, there are shown preferred embodiments.

FIG. 1 depicts a touch screen based electronic device, according to embodiments as disclosed herein. The device 101 may be at least one of a phone, a tablet, a laptop, a Personal Digital Assistant (PDA), a eBook reader, a music player, a monitor connected to a computing means (which may be co-located or located remotely from the device 101) and so on. The device 101 comprises of a display screen 102, which may be a touch screen and serves as an interface with a user of the device 101. The device 101 may comprise of other interface means, such as buttons present on the device 101, a keyboard associated with the device and so on.

On the device 101 detecting that the user is viewing text on the screen 102, the device 101 triggers a search bar 103. There may be data other than text present on the screen, such as images, icons, animations, videos and so on. The text may be present within the active session. The search bar 103 may be invisible, on being triggered. In an embodiment herein, the search bar 103 may be sufficiently transparent when triggered, so as not to interfere with the user viewing the text. The search bar 103 comprises a field for the user to enter text. The search bar 101 may also comprise a means for the user to close the search bar 103, set options related to the search operation, detailed options and so on.

The device 101 monitors the gestures of the user with respect to the screen 102. On detecting a pre-determined gesture of the user performed on the screen 102, the device 101 makes the search bar 103 visible. In an embodiment herein, the pre-determined gesture may be a single touch point from the user accompanied by an up-down scrolling gesture. The pre-determined gesture may be defined by the user using the screen 102 at any point in time.

The device 101 waits for a pre-determined time interval with the search bar 103 visible to check if the user interacts with the search bar 103 within the pre-determined time interval. The interaction may be in the form of the user entering text in the search bar 103, setting options accessible using the search bar 103 and so on. The pre-determined interval of time may be calculated from the time the search bar 103 becomes visible or the last interaction between the user and the search bar 103, whichever is later. The user may set the pre-determined time interval. If the user has not set the pre-determined time interval, the device 101 may consider the default settings as the pre-determined time interval. If the device 101 detects that the user has not interacted with the search bar 103 within the pre-determined time interval, the device 101 makes the search bar 103 invisible to the user.

On the user entering text within the search bar 103, the device 101 performs a search within the text present on the screen. The text entered by the user may be at least one of a single alphanumeric character, a string of alphanumeric characters and so on. The device 101 may perform the search in a live manner; while the user is entering the text and the results being updated as the user continues to enter text. In an embodiment herein, the device 101 may perform the search on the user entering the text and pressing an appropriate key. The appropriate key may be present on the search bar 103. The appropriate key may also be present at any location on the screen. In another embodiment herein, the device 101 may perform the search on the user starting to enter the text in the search bar 103 and not detecting any interaction from the user for a second pre-determined time interval. The user may set the second pre-determined time interval. If the user has not set the second pre-determined time interval, the device 101 may consider the default settings as the second pre-determined time interval.

The device 101 may display the results to the user in a suitable format. The suitable format may be as specified by the user.

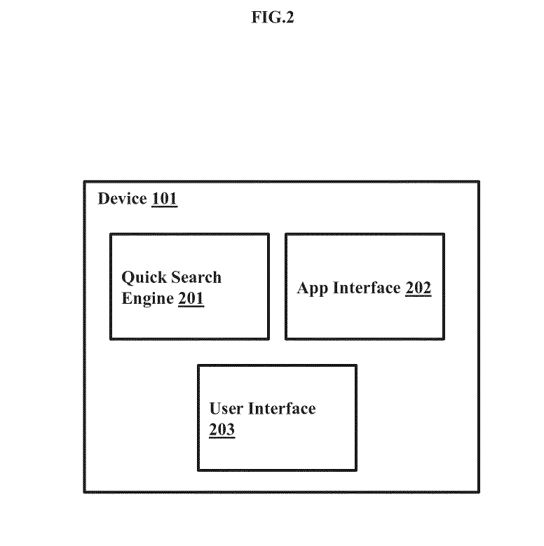

FIG. 2 depicts the internal modules present within the touch based electronic device, according to embodiments as disclosed herein. The device 101, as depicted, comprises of a quick search engine 201, an app interface 202 and a user interface 203. The app interface 202 enables the quick search engine 201 to interface with the application that the user is viewing the text. The application may at least one of a browser, a word processor, a reader, a document viewer, a file explorer, a mail application and so on. The user interface 203 may enable the quick search engine 201 to monitor the interactions and/or gestures from the user.

On the quick search engine 201 detecting that the user is viewing text on the screen 102 via the user interface 203, the quick search engine 201 triggers the search bar 103. The quick search engine 201 may configured to detect text, even if data other than text present on the screen, such as images, icons, animations, videos and so on. The quick search engine 201 may detect the text within the active session. The quick search engine 201 may make the search bar 103 invisible, on being triggered. In an embodiment herein, the quick search engine 201 may make the search bar 103 sufficiently transparent when triggered, so as not to interfere with the user viewing the text.

The quick search engine 201 monitors the gestures of the user with respect to the screen 102, via the user interface 203. On detecting the pre-determined gesture of the user performed on the screen 102 via the user interface 203, the quick search engine 201 makes the search bar 103 visible.

The quick search engine 201 waits for the pre-determined time interval with the search bar 103 visible to check if the user interacts with the search bar 103 within the pre-determined time interval. The quick search engine 201 may calculate the pre-determined interval of time from the time the search bar 103 becomes visible or the last interaction between the user and the search bar 103, whichever is later. The quick search engine 201 may enable the user to set the pre-determined time interval. If the user has not set the pre-determined time interval, the quick search engine 201 may consider the default settings as the pre-determined time interval. If the quick search engine 201 detects that the user has not interacted with the search bar 103 within the pre-determined time interval, the quick search engine 201 makes the search bar 103 invisible to the user.

On the user entering text within the search bar 103, the quick search engine 201 performs the search within the text present on the screen. The quick search engine 201 may perform the search in a live manner; while the user is entering the text and the results being updated as the user continues to enter text. In an embodiment herein, the quick search engine 201 may perform the search on the user entering the text and pressing the appropriate key. In another embodiment herein, the quick search engine 201 may perform the search on the user starting to enter the text in the search bar 103 and not detecting any interaction from the user for a second pre-determined time interval.

The quick search engine 201 may interface with the app being used by the user to access the text using the app interface 203. The quick search engine 201 communicates the text to the app using the app interface 203. The app performs a search based on the text and sends the results to the quick search engine 201. The quick search engine 201 displays the results to the user in a suitable format.

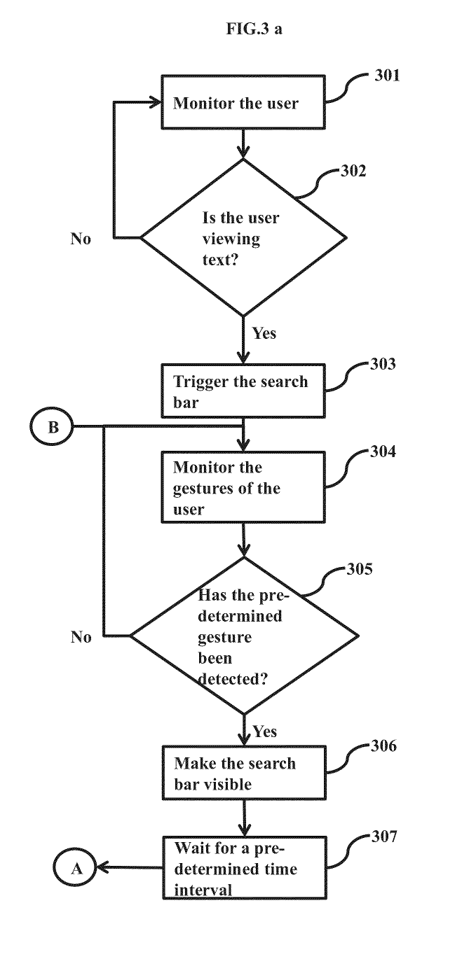

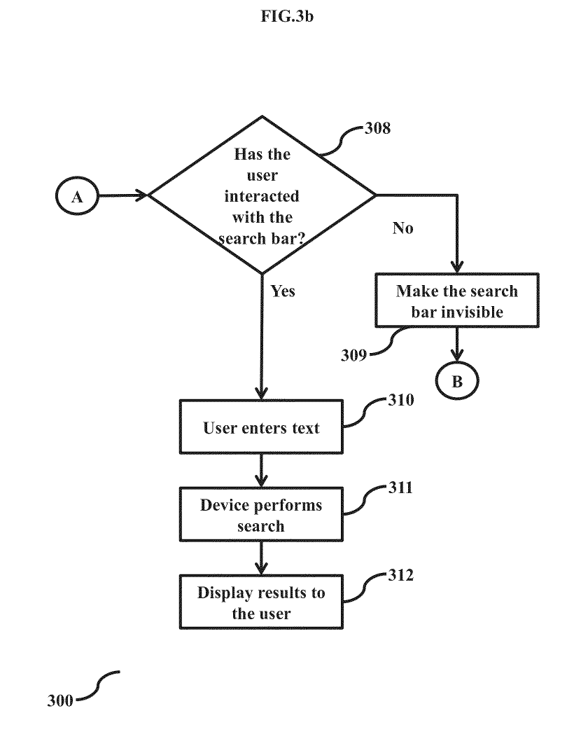

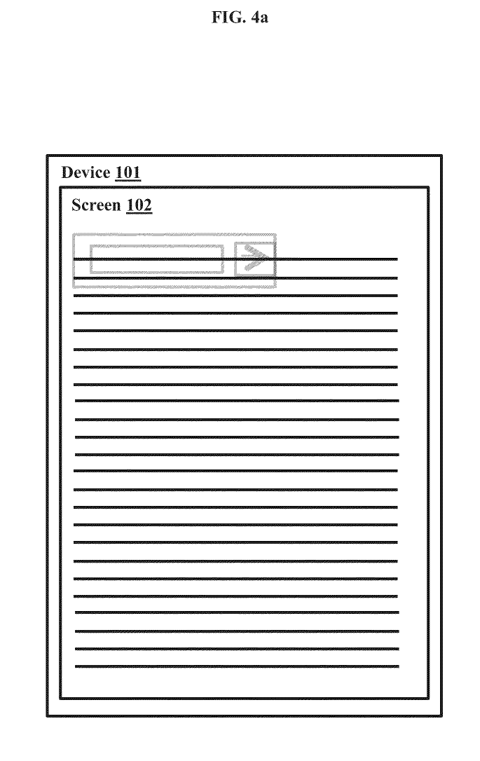

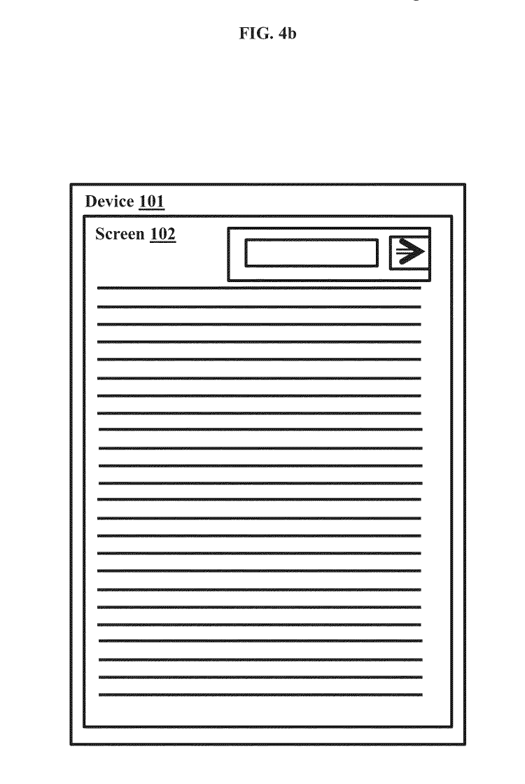

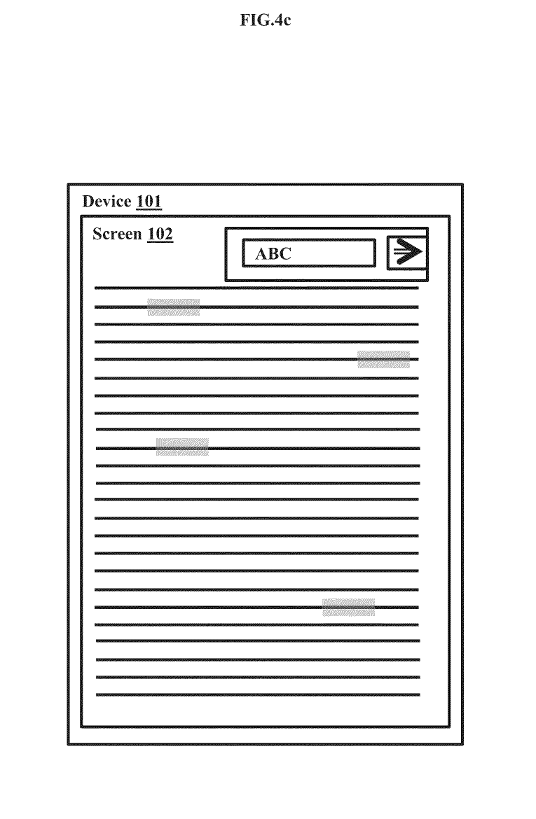

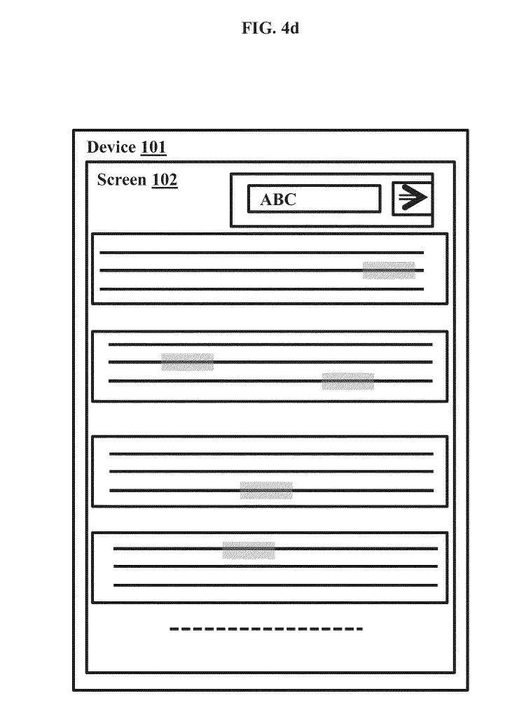

FIGS. 3a and 3b are flowcharts illustrating the process of enabling a user to perform a search in text based data on a touch screen electronic device, according to embodiments as disclosed herein. The device 101 monitors (301) to check if the user is viewing text on the screen 102. On detecting (302) that the user is viewing text on the screen 102, the device 101 triggers (303) a search bar 103 (as depicted in FIG. 4a). The device 101 may be triggered in invisible mode. In an embodiment herein, the search bar 103 may be sufficiently transparent when triggered, so as not to interfere with the user viewing the text. The device 101 monitors (304) the gestures of the user with respect to the screen 102. On detecting (305) a pre-determined gesture of the user performed on the screen 102, the device 101 makes (306) the search bar 103 visible (as depicted in FIG. 4b). The device 101 waits (307) for a pre-determined time interval with the search bar 103 visible to check if the user interacts with the search bar 103 within the pre-determined time interval. The device 101 may calculate the pre-determined interval of time from the time the search bar 103 becomes visible or the last interaction between the user and the search bar 103, whichever is later. If the device 101 detects (308) that the user has not interacted with the search bar 103 within the pre-determined time interval, the device 101 makes (309) the search bar 103 invisible to the user. On the user entering (310) text within the search bar 103, the device 101 performs (311) a search within the text present on the screen. The device 101 displays (312) the results to the user in a suitable format. The suitable format may be as specified by the user. In one embodiment herein, the results may be depicted as highlighted text within the text being viewed by the user (as depicted in FIG. 4c). In another embodiment herein, the device 101 may depict the results as excerpts from the text, with a portion of text around the searched text being displayed with the searched text being highlighted (as depicted in FIG. 4d). The various actions in method 300 may be performed in the order presented, in a different order or simultaneously. Further, in some embodiments, some actions listed in FIGS. 3a and 3b may be omitted.

The embodiments disclosed herein can be implemented through at least one software program running on at least one hardware device and performing network management functions to control the network elements. The network elements shown in FIG. 2 include blocks which can be at least one of a hardware device, or a combination of hardware device and software module.

The embodiments herein enable a user to perform a search in a text based data in a single step on a touch screen based device. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in a preferred embodiment through or together with a software program written in e.g. Very high speed integrated circuit Hardware Description Language (VHDL) another programming language, or implemented by one or more VHDL or several software modules being executed on at least one hardware device. The hardware device can be any kind of portable device that can be programmed. The device may also include means which could be e.g. hardware means like e.g. an ASIC, or a combination of hardware and software means, e.g. an ASIC and an FPGA, or at least one microprocessor and at least one memory with software modules located therein. The method embodiments described herein could be implemented partly in hardware and partly in software. Alternatively, the embodiment may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

We claim:

1. A method for enabling a user to perform a search on a touchscreen device, the method comprising of
triggering an invisible search bar by the device, on the device detecting that the user viewing text on the device;
making the search bar visible to the user by the device, on the device detecting that the user has made a pre-determined gesture; and
performing a search by the device based on the text entered by the user in the search bar.

2. The method, as claimed in claim 1, wherein the device makes the search bar invisible on not detecting any interaction from the user with the search bar for a pre-determined time interval.

3. The method, as claimed in claim 1, wherein the pre-determined gesture is defined by the user.

4. The method, as claimed in claim 1, wherein the method further comprises of presenting results of the search by the device to the user.

5. A touchscreen device configured for enabling a user to perform a search on the device, the device configured for
triggering an invisible search bar, on the device detecting that the user viewing text on the device;
making the search bar visible to the user, on the device detecting that the user has made a pre-determined gesture; and
performing a search based on the text entered by the user in the search bar.

6. The device, as claimed in claim 5, wherein the device is further configured for making the search bar invisible on not detecting any interaction from the user with the search bar for a pre-determined time interval.

7. The device, as claimed in claim 5, wherein the device is further configured for enabling the user to define the pre-determined gesture.

8. The device, as claimed in claim 5, wherein the device is further configured for presenting results of the search to the user.
